(19) United States
(12) Patent Application Publication
(10) Pub. No.: US 2010/0149247 A1
(43) Pub. Date: Jun. 17, 2010

(54) NOZZLE FUNCTIONALITY DETECTION OF INKJET PRINTERS

(75) Inventors: Ben YIP, Homebush West (AU); Peter Alleine FLETCHER, Rozelle (AU); Stephen James HARDY, West Pymble (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/620,208

(22) Filed: Nov. 17, 2009

(30) Foreign Application Priority Data
Dec. 16, 2008 (AU) 2008258159

(51) Int. Cl. B41J 29/00

(52) U.S. Cl. 347/19

(57) ABSTRACT

Methods (200), apparatuses (700), and computer program products are disclosed for detecting the functionality of a plurality of ink ejecting nozzles of a printing device. A test chart is printed (210) using the ink ejecting nozzles of the printing device. The test chart comprises line patterns. Each line pattern is associated with an ink ejecting nozzle and varies in one-dimension. The printed test chart is imaged (220) to generate an imaged test chart. Each line pattern in the imaged test chart is distinguishable from adjacent line patterns. The imaged test chart is analyzed (240) to determine if each of the line patterns exists at an expected location in the printed test chart. If at least one line pattern does not exist at an expected location, the ink ejecting nozzle corresponding to the line pattern that is not functioning is determined.

### RELATED APPLICATION

The present application claims under 35 USC 119 the benefit of the earlier filing date of Australian Patent Application No. 2008258159 filed on 16 Dec. 2008, of which the entire contents are hereby incorporated by reference.

### TECHNICAL FIELD

The present invention relates generally to inkjet printers and in particular to automated inkjet printer nozzle failure detection.

### BACKGROUND

In recent years, high quality colour printers relied heavily on two major factors, namely improvements in colour reproduction accuracy and improvements in resolution. For inkjet printers, the distances between adjacent nozzles are 20 microns or less. Precisely calibrating the movements of the printer head relative to the print medium is critical in inkjet printers. Printer defects, such as blocked printer head nozzles, present problems for colour reproduction and resolution improvement. Currently, printers are calibrated before the printers are used by customers. Nozzle failure must be detected either manually or automatically prior to the calibration process. Simple and efficient detection of blocked printer head nozzles is essential for printer quality control and subsequent printer head alignment processes.

Several technologies exist that focus on the detection of print head defects and the compensation of the defects. There are two principal techniques to detect the print head defects. One technique uses visual inspection. Patterns are printed by the printer and permit a skilled person to inspect the printed patterns and identify the defects of the print head. The second technique of detecting print head defects uses an optical sensor attached to the print head. While this technique automates the process of print head defect detection, the technique also increases the cost of the hardware involved. Accordingly, the optical sensors used typically consist of LED and economical optics, which usually cannot provide the high degree of accuracy that is required for high-end printer calibrations.

### SUMMARY

In accordance with an aspect of the invention, there is provided a method of detecting the functionality of a plurality of ink ejecting nozzles of a printing device. The method comprises the steps of: printing a test chart using the ink ejecting nozzles of the printing device, the test chart comprising a plurality of line patterns, each line pattern being associated with an ink ejecting nozzle and varying in one-dimension; imaging the printed test chart to generate an imaged test chart, each line pattern in the imaged test chart being distinguishable from adjacent line patterns; analyzing the imaged test chart to determine if each of the line patterns exists at an expected location in the printed test chart; and if at least one line pattern does not exist at an expected location, determining the ink ejecting nozzle corresponding to the line pattern is not functioning.

The method may further comprise the step of aligning the test chart and the imaged test chart.

The method may further comprise the step of determining a deviated displacement between where a line pattern is expected to exist in the printed test chart.

The pattern of each line pattern may include a noise pattern. The noise pattern of each noise pattern line may be a spread spectrum pattern.

The line patterns in the imaged test chart may be spatially separated from each other at a scale larger than a resolution used to image the test chart.

The imaging may be implemented using a scanner.

Each line pattern may be an array of a predetermined number of binary values.

The method may further comprise the step of generating the test chart, the test chart comprising N×M pixels where M is the number of the ink ejecting nozzles.

The test chart generating step may comprise: generating a plurality of line patterns; checking adjacent line patterns; and re-generating one or more adjacent line patterns if any adjacent line patterns have a significant correlation between the lines so each line pattern is distinguishable from adjacent line patterns. The method may further comprise the step of calculating a cross-correlation between two adjacent line patterns.

The test chart may comprise a plurality of columns, each comprising at least a subset of the plurality of line patterns, the number of lines in each column dependent upon the number of the ink ejecting nozzles. The line patterns may be distributed across the columns.

Each line pattern may include a pseudo-random pattern.

The method may further comprise the step of extracting a test chart region from the aligned scanned image. The method may further comprise the step of determining a vector offset between the test chart and the imaged test chart.

The analyzing step may comprise checking if a difference between a line pattern in the imaged test chart and the corresponding position in the generated test chart exceeds a predetermined threshold; and if the difference exceeds the predetermined threshold, an ink ejecting nozzle corresponding to the line pattern in the test chart is determined not to be functioning.

In accordance with another aspect of the invention, there is provided an apparatus for detecting the functionality of a plurality of ink ejecting nozzles of a printing device. The apparatus comprises a memory for storing data and instructions of a computer program for a processor unit; and a processor unit coupled to the memory and the interface. The processor unit and the memory are configured to operate dependent upon the instructions and the data. The computer program comprises: a computer program code module for printing a test chart using the ink ejecting nozzles of the printing device, the test chart comprising a plurality of line patterns, each line pattern being associated with an ink ejecting nozzle and varying in one-dimension; a computer program code module for imaging the printed test chart to generate an imaged test chart, each line pattern in the imaged test chart being distinguishable from adjacent line patterns; a computer program code module for analyzing the imaged test chart to determine if each of the line patterns exists at an expected location in the printed test chart; and a computer program code module for, if at least one line pattern does not exist at an expected location, determining the ink ejecting nozzle corresponding to the line pattern is not functioning.

The apparatus may further comprise a printing device for printing the test chart; and an imaging device for imaging the printed test chart.

In accordance with still another aspect of the invention, there is provided a computer program product comprising a tangible computer readable medium having a computer program recorded on the medium for execution by a computer system to detect the functionality of a plurality of ink ejecting nozzles of a printing device. The computer program comprises: a computer program code module for printing a test chart using the ink ejecting nozzles of the printing device, the test chart comprising a plurality of line patterns, each line pattern being associated with an ink ejecting nozzle and varying in one-dimension; a computer program code module for imaging the printed test chart to generate an imaged test chart, each line pattern in the imaged test chart being distinguishable from adjacent line patterns; a computer program code module for analyzing the imaged test chart to determine if each of the line patterns exists at an expected location in the printed test chart; and a computer program code module for, if at least one line pattern does not exist at an expected location, determining the ink ejecting nozzle corresponding to the line pattern is not functioning.

### BRIEF DESCRIPTION OF THE DRAWINGS

Embodiments of the present invention are described hereinafter with reference to the drawings, in which:

FIG. 1 is a schematic block diagram of a general-purpose computer, with which the embodiments of the invention may be practised;

FIG. 2 is a schematic flow diagram of a method of detecting printer head nozzle failure;

FIG. 3 is a flow diagram illustrating a method of generating a column of a test chart;

FIG. 4 is an image illustrating a portion of a column of a digital test chart;

FIG. 5 is a block diagram providing a simplified representation of one type of the mechanical layout of an inkjet printer;

FIG. 6 is a block diagram illustrating a typical layout of ink ejection nozzles of an inkjet print head;

FIG. 7 is a block diagram showing an imaging system comprising a flat bed scanner coupled to a computer;

FIG. 8 is an image showing a scanned image of four columns of a printed chart and an enlarged line pattern of that chart;

FIG. 9 is a schematic flow diagram of a method of aligning the scanned image with its digital test chart; and

FIG. 10 is a block diagram illustrating the actions of inks ejected from a print head of an inkjet printer.

### DETAILED DESCRIPTION

Methods, apparatuses, systems, and computer program products are disclosed for detecting the functionality of a plurality of ink ejecting nozzles of a printing device. In the following description, numerous specific details, including particular sizes of line patterns, inks and colourants, print feed mechanisms, and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings/figures to steps and/or features, which have the same reference numerals, those steps and/or features have for the purposes of this description the same function(s) or operation(s), unless the contrary intention appears.

Methods are described of detecting the nozzle failure of an ink jet printer using generated patterns that are printed on a print medium, imaging the printed test patterns, and analysing the images to detect the printer nozzle failure.

### [Processing Environment]

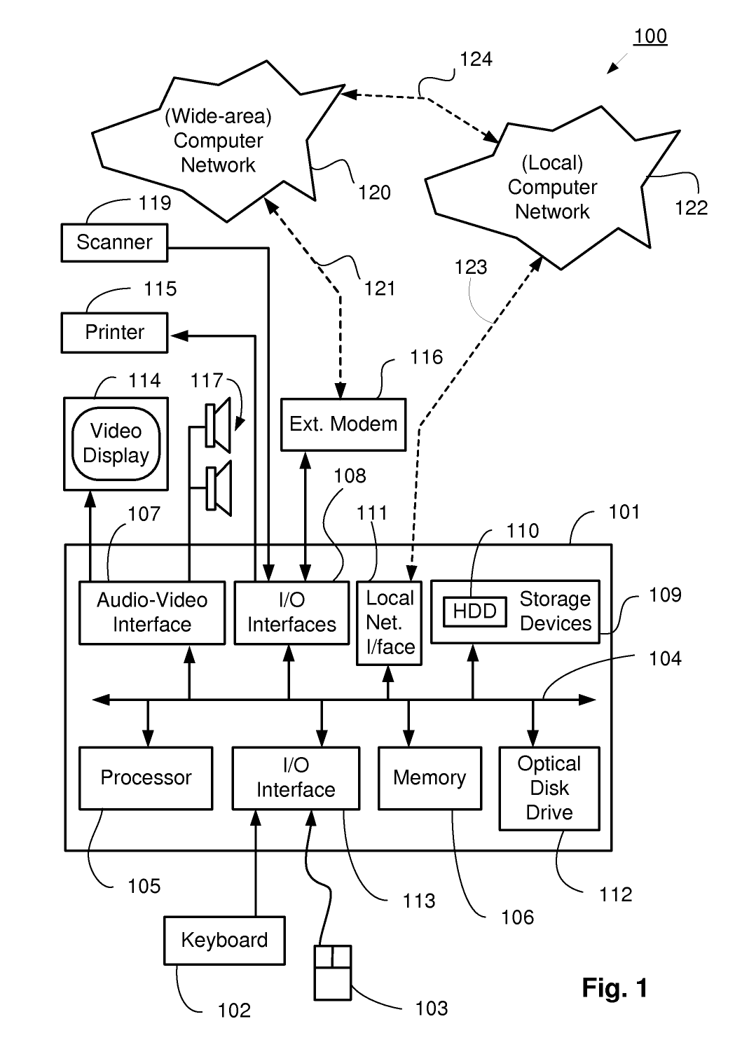

A method of detecting printer nozzle failure may be implemented using a computer system 100, such as that shown in FIG. 1. The method may be implemented as software, such as one or more application programs executable within the computer system 100. In particular, the steps of the method of detecting printer nozzle functionality, e.g. failure, are effected by instructions in the software that are carried out within the computer system 100. The instructions may be formed as one or more code modules, each for performing one or more particular tasks. The software may also be divided into two separate parts, in which a first part and the corresponding code modules perform the detection of the blocked nozzles and a second part and the corresponding code modules manage a user interface between the first part and the user. The software may be stored in a computer readable medium, including the storage devices described hereinafter, for example. Examples of tangible computer readable media are given. The software is loaded into the computer system 100 from the computer readable medium, and executed by the computer system 100. A computer readable medium having such software or computer program recorded on the computer readable medium is a computer program product. The use of the computer program product in the computer system 100 preferably effects an advantageous apparatus for image processing, particularly for nozzle failure detection.

As seen in FIG. 1, the computer system 100 comprises a computer module 101, input devices such as a keyboard 102, a mouse pointer device 103 and a scanner 119, and output devices including a printer 115, a display device 114 and loudspeakers 117. An external Modulator-Demodulator (Modem) transceiver device 116 may be used by the computer module 101 for communicating to and from a communications network 120 via a connection 121. The network 120 may be a wide-area network (WAN), such as the Internet or a private WAN. Where the connection 121 is a telephone line, the modem 116 may be a traditional “dial-up” modem. Alternatively, where the connection 121 is a high capacity (eg: cable) connection, the modem 116 may be a broadband modem. A wireless modem may also be used for wireless connection to the network 120.

The computer module 101 typically includes at least one processor unit 105, and a memory unit 106 for example formed from semiconductor random access memory (RAM) and read only memory (ROM). The module 101 also includes an number of input/output (I/O) interfaces including an audio-video interface 107 that couples to the video display 114 and loudspeakers 117, an I/O interface 113 for the keyboard 102 and mouse 103 and optionally a joystick (not illustrated), and an interface 108 for the external modem 116, scanner 119 and printer 115. In some implementations, the modem 116 may be incorporated within the computer module 101, for example within the interface 108. The computer module 101 also has a local network interface 111 which, via a connection 123, permits coupling of the computer system 100 to a local computer network 122, known as a Local Area Network (LAN). As also illustrated, the local network 122 may also couple to the wide-area network 120 via a connection 124, which typically includes a so-called “firewall” device or similar functionality. The interface 111 may be formed by an Ethernet™ circuit card, a wireless Bluetooth™ or an IEEE 802.11 wireless arrangement. The networks 120 and 122 may represent sources of image data, and image data may also be sourced from the scanner 119. The scanner 119 may be a flatbed scanner for scanning documents.

The interfaces 108 and 113 may afford both serial and parallel connectivity, the former typically being implemented according to the Universal Serial Bus (USB) standards and having corresponding USB connectors (not illustrated). Storage devices 109 are provided and typically include a hard disk drive (HDD) 110. Other devices such as a floppy disk drive and a magnetic tape drive (not illustrated) may also be used. An optical disk drive 112 is typically provided to act as a non-volatile source of data. Portable memory devices, such optical disks (eg: CD-ROM, DVD), USB-RAM, and floppy disks for example may then be used as appropriate sources of data to the system 100.

The components 105, to 113 of the computer module 101 typically communicate via an interconnected bus 104 and in a manner which results in a conventional mode of operation of the computer system 100 known to those skilled in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 110 and read and controlled in execution by the processor 105. Intermediate storage of such programs and any data, such as image data, fetched from the networks 120 and 122 or scanner 119 may be accomplished using the semiconductor memory 106, possibly in concert with the hard disk drive 110. In some instances, the application programs may be supplied to the user encoded on one or more CD-ROM and read via the corresponding drive 112, or alternatively may be read by the user from the networks 120 or 122. Still further, the software can also be loaded into the computer system 100 from other computer readable media. Computer readable media refers to any storage medium that participates in providing instructions and/or data to the computer system 100 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 114. Through manipulation of the keyboard 102 and the mouse 103, a user of the computer system 100 and the application may manipulate the interface to provide controlling commands and/or input to the applications associated with the GUI(s).

The methods to be described may also be implemented, at least in part, in dedicated hardware such as one or more integrated circuits performing the functions or sub functions to be described. Such dedicated hardware may include graphic processors, digital signal processors, or one or more microprocessors and associated memories.

### [Procedures]

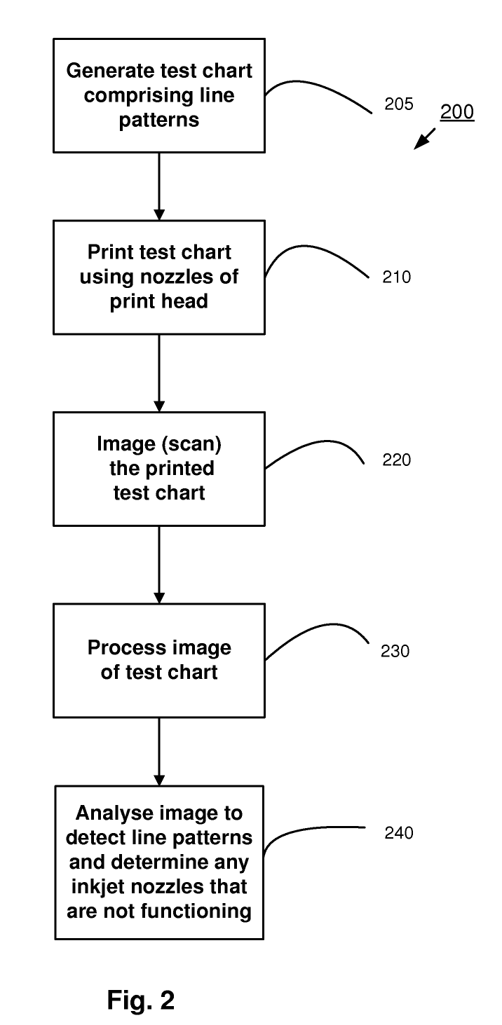

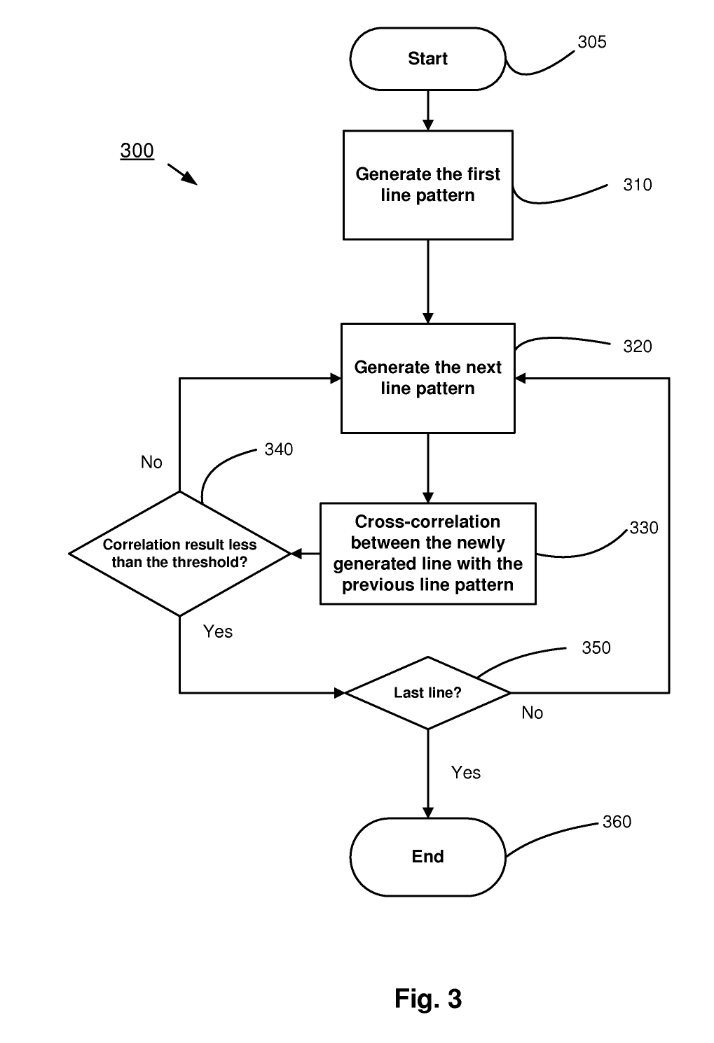

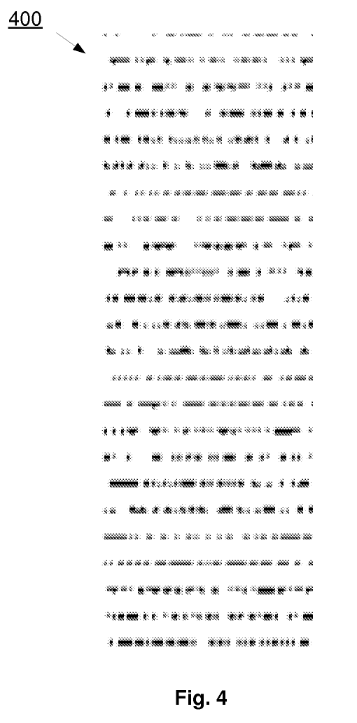

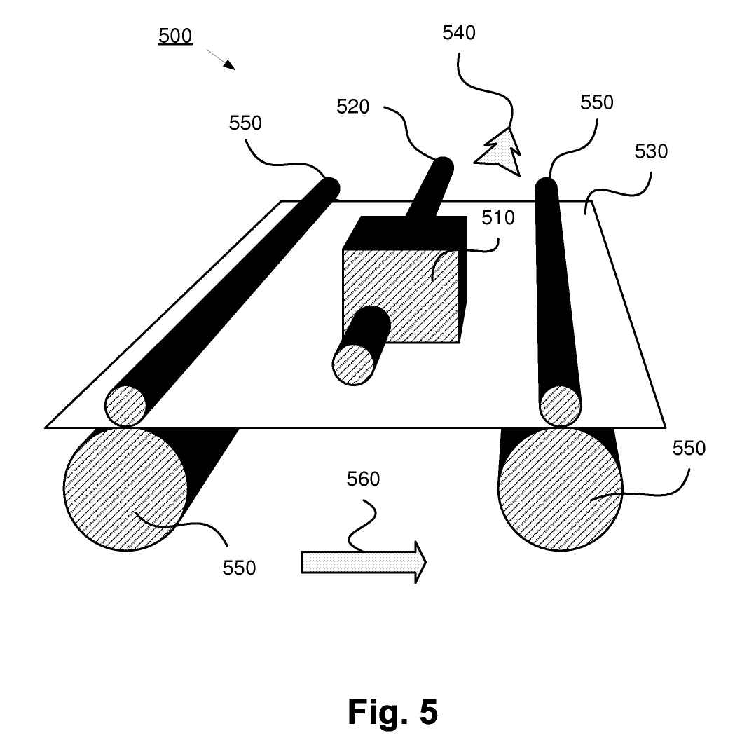

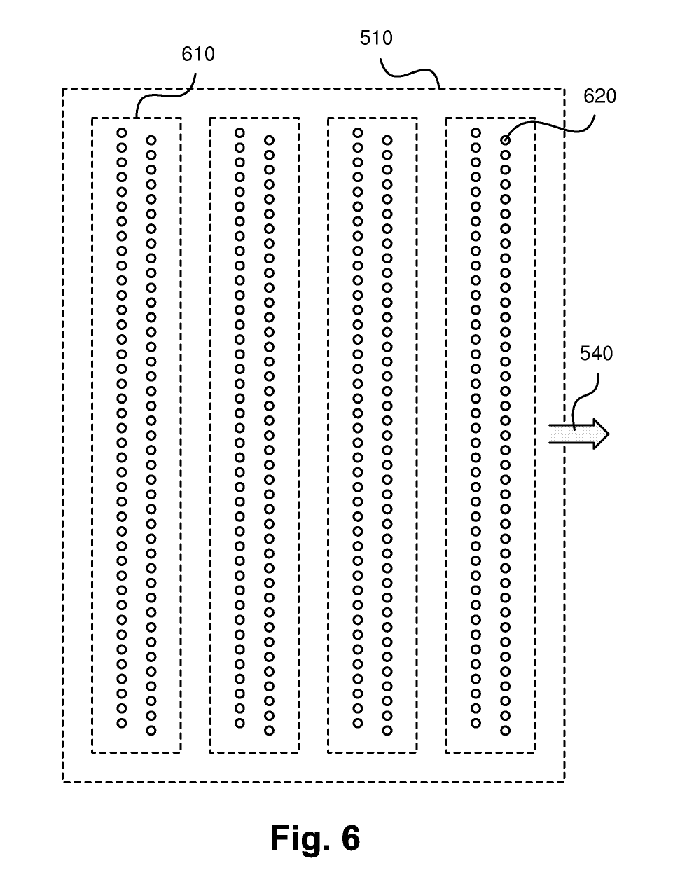

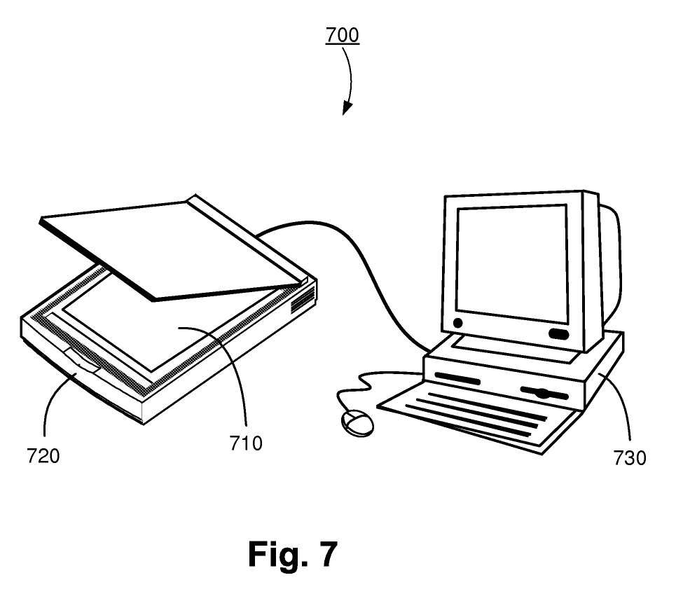

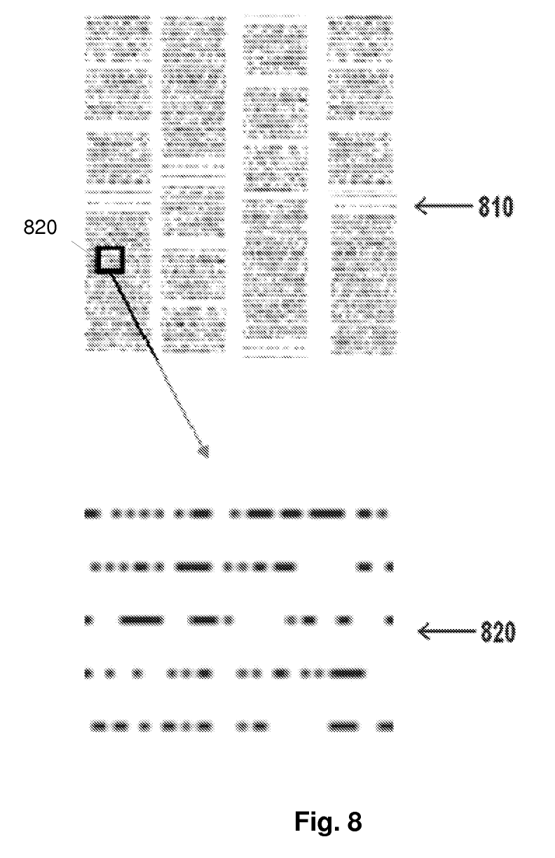

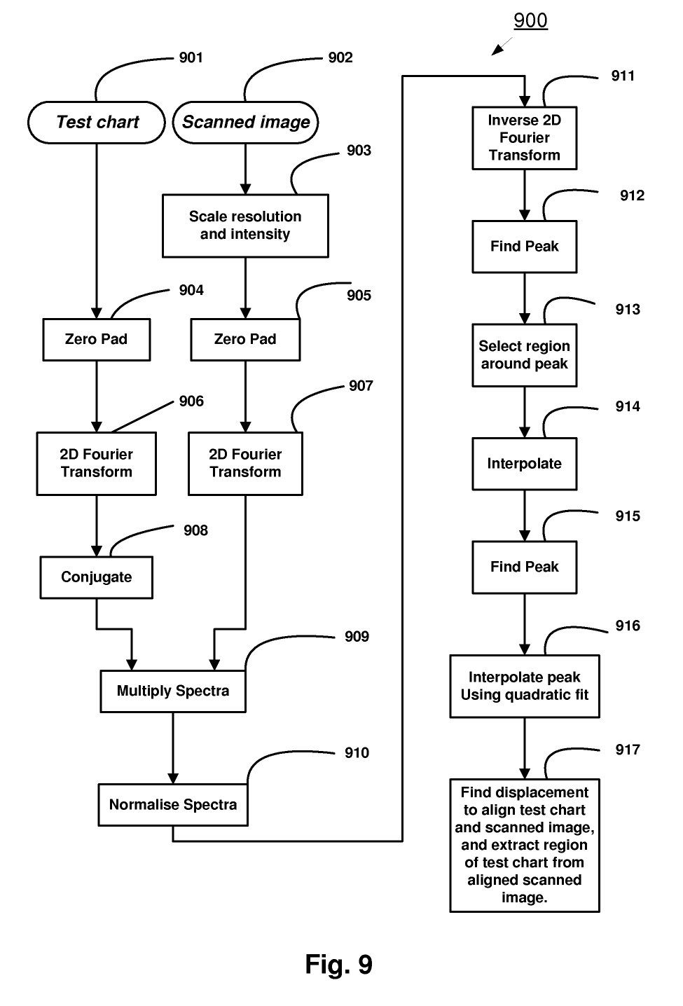

FIG. 2 shows a method 200 of detecting printer head nozzle failure detection. In step 205, a test chart is generated using the processor 105. The generated test chart may be stored in the memory 106. The step 205 generates the test chart comprising the line patterns. This step is described in detail with reference to FIGS. 3 and 4. In step 210, the test chart is printed by printer 115 with the nozzle bank of the print head to be tested. The test chart may be transferred from the memory 106 via the interface 108 to the printer 115. The step 210 is described in detail with reference to FIGS. 5 and 6. In step 220, the printed chart is scanned by the scanner 119 to obtain the scanned image. The image of the printed test chart may be transferred from the scanner 119 to the memory 106 via the interface 108. The step 220 is described in detail with reference to FIGS. 7 and 8. In step 230, the processor 105 processes the scanned image and the digital test chart image. This step 230 is described in detail with reference to FIG. 9. In step 240, the image of the printed test chart and the test chart are analysed by the processor 105 to detect line patterns and determine the functionality of the inkjet nozzles based on the line pattern. The imaged test chart is analysed to determine if each of the noise pattern lines exists at an expected location in the printed test chart. Each noise pattern line may be an array of a predetermined number of binary values. The noise pattern lines may be distributed across columns The method 200 then ends.

### [Test Chart Generation]

FIG. 3 is a flow diagram of the method 300 of generating a column of the test chart using the processor unit 105 and the memory 106. The test chart comprises multiple columns of digital patterns, and the process of generating them is the same. In an exemplary embodiment, each digital pattern is a line pattern line varying in one-dimension. The digital patterns have pixel values of 0 (do not print dot) or 1 (print dot). Starting from step 305, the test chart is generated line by line. Each line comprises N pixels, each with a value of either 1 or 0. In an exemplary embodiment shown in FIG. 4, the number of pixels in each line, N, is equal to 100 in the portion 400 of the column However, any suitable values may be used. A line is deemed to be blank if all N pixel values in the line have the value 0. A line is deemed to be a line pattern if the line is not blank.

The number of lines in each column depends on the number of nozzles required to be tested in a bank of the print head, the resolution of the print head and the scanning device, and the area in the test chart. The basic idea of the test chart layout is for each nozzle to print one line pattern in one of the columns In other words, the test chart of a print head of 512 nozzles has 512 line patterns generated.

One way to ensure the line patterns on the printed test chart are spatially separated is by scattering the line patterns evenly across the columns For example, in a test chart with 8 columns, the first line pattern is printed in column 1. The line pattern printed by the second nozzle is printed in column 2. The line pattern printed by the 8^{th} nozzle is in column 8. As there are 8 columns, the line pattern printed by the 9^{th} nozzle is printed back in column 1. In other words, in the K-th column, the line patterns are printed in line K, line K+8, line K+16, and so on. All other lines in the columns are blank lines.

In step 310, the first line pattern is generated by the processor 105. The series of distinctive line patterns may be generated in a number of different ways. One method of generating such patterns is by permutation of an N bit binary sequence with a suitable number of ones and zeros. In this way, the neighbouring data series can be made distinctive by using a factoradic numbers incremented with a suitable co-prime, or by randomly permutating the N bit binary sequence. then some cases, a pseudo-random pattern such a noise like data pattern can be used as the reverse process of looking up the permutation index from a generated permutation data pattern is not required.

In an exemplary embodiment discussed below, a pseudo-random pattern is used.

Each line pattern has pattern N pixels (e.g N=100). A random number between 0 and 1 is generated for each pixel in the line using a random number generation method, many of which are well known to those skilled in the art. If the generated random number is less than a threshold, say 0.5, that pixel value is set to 0; otherwise, the pixel value is set to 1. In step 320, the next line pattern is generated in a similar manner. Because of the randomness involved, every line pattern in a test chart is almost certainly different, because N is large. Also, because of the randomness involved, the line pattern likely has a spread spectrum, that is, the line pattern has low auto-correlation. The line pattern being a spread spectrum pattern is a characteristic of the randomness involved, not a required condition for this embodiment to achieve high performance.

In step 330, the cross correlation between the newly generated line pattern and the previous line pattern is calculated by the processor 105. If the newly generated line pattern has a significant correlation with the previous line pattern, which is unlikely, a new line pattern line shall need to be re-generated. One possible implementation of measuring the significance of a correlation is as follows:

A line pattern can be considered as an array of N binary integers. Let A be a line pattern, and B be another line pattern. A is said to be similar to B if:

$$\frac{max ( xcorr ( A , B ) )}{‖ A ‖ \cdot ‖ B ‖} > threshold ,$$

where xcorr(A,B) denotes the cross-correlation, also known as the sliding dot product, between A and B. ∥A∥ and ∥B∥ denote the L2-norm of A and B. For example, the threshold value may be 0.85.

In decision step 340, the cross-correlation result calculated in step 330 is used to determine if the two line patterns are similar. If yes, the pattern line is regenerated in step 320. Otherwise (No), the generated pattern line is accepted and stored in the memory 106. In decision step 350, a check is made to determine if the current line is the last line pattern of the column If it is not the last line pattern of the column (No), step 320 is carried out to generate the next line pattern. On the other hand, if the current line is the last line pattern in this column (Yes), the pattern line generation 300 ends at step 360. This concludes the generation of a column the test chart.

FIG. 4 illustrates an exemplary column 400 of the test chart generated by the above described method 300. In this example, the dimensions of test chart are 100×512 pixels. There are 512 lines in this column, 64 of the lines are line patterns and 448 of the line are blank lines. However, any suitable dimension may be used, depending, for example, on the number of nozzles on a printer and the print medium where the test chart is to be printed on. Nevertheless, each pattern line is ensured to be spatially separated at scales larger than the resolution of the scanner 720 in FIG. 7 used, and each pattern line is distinguishable from its neighboring pattern lines.

### [Printing]

FIG. 5 is a simplified representation of the internal arrangement of an inkjet printer 500. The arrangement 500 comprises a print head 510 having ink ejection nozzles (not illustrated) organised into groups based on colour and/or ink volume. The print head 510 is mounted on a carriage 520 which traverses a print medium 530 and forms image swaths during a forward passage in a print head scan direction 540 and a back passage opposite to the print head scan direction 540, by controlling the ejection of ink from the ink ejection nozzles within the nozzle banks. The inkjet printer further comprises a print medium advance mechanism 550 comprising pairs of rollers, which transports the print medium 530 in a direction 560 perpendicular to the print head scan direction 540. FIG. 5 is only one example of the type of printer that the embodiments of the invention can be applied to. The embodiments of the invention can be equally applied to a printer with a full-width fixed head printer (not shown). For this type of printer, the print head is stationary and forms an image by controlling the ejection of ink from the ink ejection nozzles within the nozzle banks while the print medium advance mechanism transports the print medium.

FIG. 6 illustrates an exemplary layout of a print head 510 with four ink eject nozzle banks, the bank 610 being the first bank. Each nozzle bank comprises multiple ink ejection nozzles 620 extending perpendicularly to the print head scan direction 540. Again, the embodiments of this invention can be applied to printers with different nozzle bank configurations as well.

For an inkjet printer to produce images that do not contain noticeable visual artefacts, alignment is required between the nozzle banks 610 used within the same passage and between the nozzle banks 610 used during the forward and back passages respectively. The print medium advance mechanism 550 must also be calibrated to advance the print medium 530 to correctly align swaths.

In this exemplary embodiment, there are 512 nozzles in each bank of the print head. If there are M columns in the test chart, each column has 512/M line patterns, and each line pattern is separated by M-1 blank lines. The position of the first line pattern of each column is different. For example, the first line pattern of the first column is at the first line position of that column; the first line pattern within_the second column is at the second line position of that column In general, the first line pattern in column M is at line position M of column M. When printing, the printer is instructed such that each non-blank line (line pattern) is printed with a corresponding nozzle. Each nozzle prints a unique line pattern. The line pattern is previously generated and can be read from the memory 106. After the generated test chart is printed, each nozzle should have printed one line pattern in one of the columns, i.e. each nozzle has an associated line pattern. The columns of the test chart can be printed on the same piece of print medium or in multiple different print mediums.

When printing, a functioning nozzle prints a line pattern, a blocked nozzle leaves a blank line on the printout, and an imperfect (e.g. partially blocked) nozzle prints a line deviated from the expected position. The nozzle failure is detected and identified by analyzing the printed test pattern. If there is a blank line where a printed line is expected, then nozzle failure can be identified.

### [Imaging]

Referring to FIG. 2, after printing the test chart 210, the next step 220 is to image (scan) the printed test chart.

FIG. 7 shows an imaging system 700 for detecting the nozzle failures. The printed test chart 710 is imaged with an optical device, such as a scanner 720 in the system 700. For the purpose of this embodiment, the test chart is scanned as a grey scale image. FIG. 8 shows a scanned image of four columns of the printed chart 810 with a 600 dpi scanner and an enlarged image of pattern lines 820.

### [Processing]

Referring to FIG. 2, after imaging 220 the printout, the next step is to process 230 the scanned image. The processing 230 of the images comprises two steps: one step is to align the scanned image to the test chart, and the other step is to extract the aligned test chart region from the scanned image.

A number of different alignment techniques may used to align the scanned image to the test chart. FIG. 9 shows a schematic flow diagram of a method 900 of aligning the scanned image with its digital test chart, using phase correlation.

Method 900 calculates the displacement to align the test chart 901 and scanned image 902. The scanned image resolution depends on the scanner 720 used, for example, 600 dpi. The test chart resolution depends on the resolution of the print head, for example, 1200 dpi. The scanned image 902 is scaled to the same resolution of test chart resolution 903.

The grey scale intensity of the scanned image, for example, could range from 0 (black) to 255 (white). In this case, the grey scale intensity values of the scanned image are also scaled in step 903 from the grey scale intensity values of 0 (representing black) to 255 (representing white) to binary values of 0 (representing white) to 1 (representing black), which is the intensity scale of the test chart. For example, if the grey scale intensity of the scanned image is smaller than 125, the intensity value is set to be 0; and if the grey scale intensity of the scanned image is greater than 125 the intensity value is set to be 1.

For the alignment process, both the generated digital test chart 901 and the scanned image after step 903 are made to have the same width and same height. This can be done by padding white (zero) in one or both dimensions in steps 904 and 905. Padding also reduces aliasing artefacts in the subsequent processing stages. The padding size may be chosen such that the resultant padded image region is a size suitable for a computationally efficient implementation of the subsequent 2D Fourier transform.

The rest of the alignment process operates on two equal sized images 904 and 905 and calculates a high resolution displacement 917 between the features within the two patch images. In particular, the displacement in step 917 is a vector offset difference between the images 904 and 905. Then image 905 is aligned with image 904 according to the vector offset difference between the generated test chart and the scanned test chart which are extracted 917. The process relies on the two images containing similar image data that may be at different spatial positions within their respective image regions.

In an exemplary embodiment, the alignment process proceeds as follows. In steps 906 and 907, a 2-Dimensional Fourier Transform is applied to the padded images respectively to form spectra. Both spectra 906 and 907 are two dimensional, complex valued arrays. A conjugated spectrum is formed in step 908 from the spectrum 906 for the test chart by negating the imaginary part of spectrum.

In step 909, the two complex spectra 908 and 907 of the test chart 901 and the scanned image 902 respectively are then combined by multiplying the arrays on an element by element basis to form correlation spectrum. In step 910, the correlation spectrum 909 is further processed where the amplitudes of the complex valued correlation spectrum 909 are unitised to form a normalised phase correlation spectrum 910.

A 2-Dimensional Inverse Fourier Transform is then applied in step 911 to the normalised correlation spectrum 910 to form a correlation amplitude image.

In step 912, the peak is found in the correlation. The largest absolute amplitude value in the correlation amplitude image 911 is determined The offset from the image centre of this largest amplitude value gives a coarse peak position 912, measured in whole image pixels.

In step 913, the region around the peak is selected. An image region, known as the peak image region, is cropped from the correlation amplitude image 911 in the vicinity of the coarse peak position. This peak image region is smaller than the correlation amplitude image 911 to reduce the computational requirements of the subsequent processing stages.

In step 914, the peak image region 913 is interpolated. This may be done in both dimensions by an integer factor using up-sampling and linear filtering. In step 915, the peak is found in the up-sampled image 914. The interpolation allows the position of the peak to be determined with sub-pixel resolution.

Further improvement to the accuracy of the peak position determination is performed in step 916 by interpolation using quadratic polynomials. The quadratic interpolation is performed by fitting a quadratic polynomial to the image elements in the immediate vicinity of the peak, using, for example, least squares error criteria. The quadratic polynomial is then solved analytically to obtain the position of the peak.

The offset from the image centre to the location of the interpolated peak is the fine displacement 917 of this alignment process. The resultant displacement obtained has an accuracy that is significantly greater than the resolution of the original patch images 901 and 902, and the interpolated correlation image.

The resultant displacement found in step 917 is used to align the test chart 901 and the scanned scaled image 903. Based on the resultant displacement, a region, which has the same dimension as the test chart, is extracted from the aligned scanned image. This extracted region should look substantially similar to the test chart. This extracted region is used for analysis described in detail hereinafter.

The above described procedures are applied to each of the columns of the scanned images and their corresponding test chart images.

### [Analysing]

Referring to FIG. 2, after the step 230 of aligning the scanned image to the test chart and extracting the aligned test chart region from the scanned image, the next step 240 is to analyse the images and identify any failed nozzle.

Let D be the K-th line pattern of a digital pattern in the test chart, as read from the memory 106. D is a vector of N binary numbers (e.g. N=100). Let S be the K-th row of pixels from the aligned, scaled, scanned image. S is a vector of N real numbers with values near 0 or 1. If the nozzle that prints the K-th pattern line of the digital pattern is functioning, S should look substantially similar to D. If the nozzle that prints the K-th line pattern of the digital pattern has failed, or significantly deviated, S should be blank, or is substantially different from D.

In the exemplary methods of deciding if the K-th nozzle has failed, the image intensity difference between D and S is analyzed. In another exemplary method, the correlation coefficient of D and S is analyzed.

For the image intensity difference method, the intensity difference between D and S is calculated as follows:

IntensityDiff(D,S)=AverageIntensity(D)−AverageIntensity(S).

If the difference of the intensity of D and K, denoted by IntensityDiff(D,S), is greater than a pre-determined threshold, the nozzle that is supposed to have printed S is concluded to have failed. In this embodiment, threshold=0.2.

For the correlation coefficient method, the correlation coefficient between D and S is calculated. The correlation coefficient is defined as:

$$CorrelationCoefficient ( D , S ) = \frac{E ( DS ) - E ( D ) E ( S )}{\sqrt{E ( {D}^{2} ) - {E}^{2} ( D )} \sqrt{E ( {S}^{2} ) - {E}^{2} ( S )}} ,$$

where E(x) denotes the expectation value of a vector x.

If the correlation coefficient is less than a threshold value, the nozzle that is supposed to have printed S is concluded to have failed. In this embodiment, threshold=0.15.

By applying the above analysis to each of the line of each of the column, the failed nozzle is detected and identified.

[Deviated Displacement]

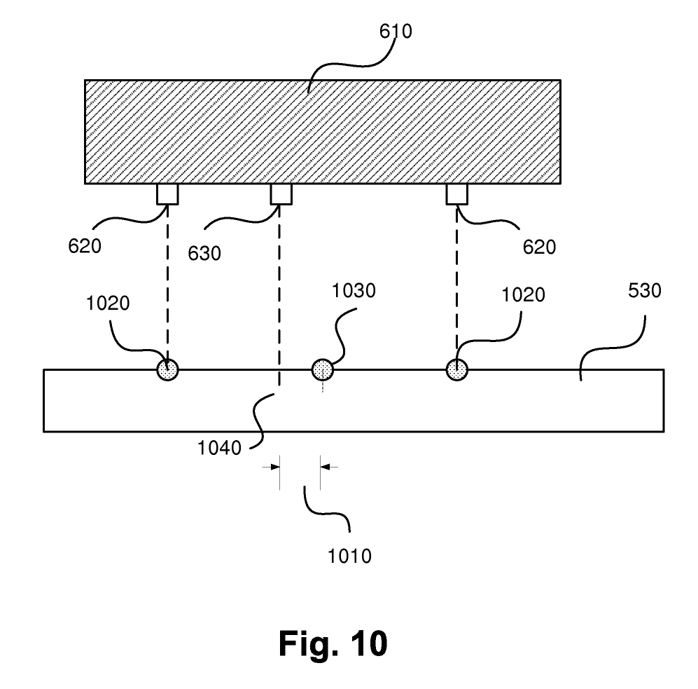

FIG. 10 illustrates the actions of inks ejected from the print head 610. The arrangement comprises a print head 610 having ink ejection nozzles 620, 630 (only several nozzles are drawn), ejecting inks onto a print medium 530 and forming corresponding ink dots 1020, 1030. Because of external factors such as dust or air motion, or the imperfection of nozzle manufacturing, the ink dots, for example 1030, may not land at the expected location 1040 on the print medium 530. The displacement between where an ink dot is supposed to be and its actual location is called the deviated displacement 1010 of a nozzle.

Referring to FIG. 2, after the step 230 of aligning the scanned image to the test chart and extracting the aligned test chart region from the scanned image, the next step 240 is to analyse the images. In addition to detecting and identifying any failed nozzle, the deviated displacement of each functioning nozzle can also be calculated.

Let D be the K-th pattern line of a digital pattern in the test chart. D is a vector of N binary numbers (e.g. N=100). Let S be an image region extracted from the aligned, scaled, scanned image. S is selected in a way that the K-th row of pixel is located in the middle of S, and the K-th line pattern is the only line pattern in S. Because the actual location of the K-th line pattern in S is unknown, S should have multiple rows of pixels to cover more extreme cases. For example, if the line patterns are printed with 8 nozzles apart, S could have 11 rows of pixels. If the K-th nozzle has no deviated displacement, the K-th pattern line would appear in the middle of S. If the K-th nozzle has a deviation of 10 microns, the K-th pattern line appears at around half of a pixel (for 1200 dpi) below the middle. In other words, the displacement of the K-th pattern line, D, in S indicates the deviated displacement of the K-th nozzle.

FIG. 9 shows a schematic flow diagram of the method of aligning images, as described hereinbefore. The method 900 in FIG. 9 could also be used to find the displacement between D and S. Let D be the test chart 901 and S be the scanned image 902. Following the steps in FIG. 9, the displacement vector between D and S is obtained in the step 917. Let (x, y) be the calculated displacement vector between D and S. The deviated displacement is defined in the vertical direction of the test chart, hence the deviated displacement equals the y value in (x, y).

By applying the above analysis to each of the line of each of the column, the deviated displacements of each functioning nozzles can be calculated.

Methods, apparatuses, systems, and computer program products have been disclosed for detecting the functionality of a plurality of ink ejecting nozzles of a printing device. The embodiments of the invention are applicable to the computer and data processing industries, and in particular to printing technology industries, amongst others. The foregoing describes only some embodiments of the present invention, and modifications and/or changes can be made thereto without departing from the scope and spirit of the invention, the embodiments being illustrative and not restrictive.

1. A method of detecting the functionality of a plurality of ink ejecting nozzles of a printing device, said method comprising the steps of:
printing a test chart using said ink ejecting nozzles of said printing device, said test chart comprising a plurality of line patterns, each line pattern being associated with an ink ejecting nozzle and varying in one-dimension;
imaging said printed test chart to generate an imaged test chart, each line pattern in the imaged test chart being distinguishable from adjacent line patterns;
analyzing said imaged test chart to determine if each of said line patterns exists at an expected location in said printed test chart; and
if at least one line pattern does not exist at an expected location, determining the ink ejecting nozzle corresponding to said line pattern is not functioning.

2. The method according to claim 1, further comprising the step of aligning said test chart and said imaged test chart.

3. The method according to claim 1, further comprising the step of determining a deviated displacement between where a line pattern is expected to exist in said printed test chart.

4. The method according to claim 1, wherein the pattern of each line pattern includes a noise pattern.

5. The method according to claim 4, wherein the noise pattern of each noise pattern line is a spread spectrum pattern.

6. The method according to claim 1, wherein said line patterns in said imaged test chart are spatially separated from each other at a scale larger than a resolution used to image said test chart.

7. The method according to claim 1, wherein said imaging is implemented using a scanner.

8. The method according to claim 1, wherein each line pattern is an array of a predetermined number of binary values.

9. The method according to claim 1, further comprising the step of generating said test chart, said test chart comprising N×M pixels where M is the number of said ink ejecting nozzles.

10. The method according to claim 9, wherein said test chart generating step comprises:
generating a plurality of line patterns;
checking adjacent line patterns; and
re-generating one or more adjacent line patterns if any adjacent line patterns have a significant correlation between said lines so each line pattern is distinguishable from adjacent line patterns.

11. The method according to claim 10, further comprising the step of calculating a cross-correlation between two adjacent line patterns.

12. The method according to claim 1, wherein said test chart comprises a plurality of columns, each comprising at least a subset of said plurality of line patterns, the number of lines in each column dependent upon the number of said ink ejecting nozzles.

13. The method according to claim 10, wherein said line patterns are distributed across said columns.

14. The method according to claim 1, wherein each line pattern includes a pseudo-random pattern.

15. The method according to claim 2, further comprising the step of extracting a test chart region from said aligned scanned image.

16. The method according to claim 15, further comprising the step of determining a vector offset between said test chart and said imaged test chart.

17. The method according to claim 1, wherein said analyzing step comprises checking if a difference between a line pattern in said imaged test chart and the corresponding position in the generated test chart exceeds a predetermined threshold; and
if the difference exceeds said predetermined threshold, an ink ejecting nozzle corresponding to said line pattern in said test chart is determined not to be functioning.

18. An apparatus for detecting the functionality of a plurality of ink ejecting nozzles of a printing device, said apparatus comprising:
a memory for storing data and instructions of a computer program for a processor unit; and
a processor unit coupled to said memory and said interface, said processor unit and said memory configured to operate dependent upon said instructions and said data, said computer program comprising:
computer program code means for printing a test chart using said ink ejecting nozzles of said printing device, said test chart comprising a plurality of line patterns, each line pattern being associated with an ink ejecting nozzle and varying in one-dimension;
computer program code means for imaging said printed test chart to generate an imaged test chart, each line pattern in the imaged test chart being distinguishable from adjacent line patterns;
computer program code means for analyzing said imaged test chart to determine if each of said line patterns exists at an expected location in said printed test chart; and
computer program code means for, if at least one line pattern does not exist at an expected location, determining the ink ejecting nozzle corresponding to said line pattern is not functioning.

19. The apparatus according to claim 18, further comprising:
a printing device for printing said test chart; and
an imaging device for imaging said printed test chart.

20. A computer program product comprising a tangible computer readable medium having a computer program recorded on said medium for execution by a computer system to detect the functionality of a plurality of ink ejecting nozzles of a printing device, said computer program comprising:
computer program code means for printing a test chart using said ink ejecting nozzles of said printing device, said test chart comprising a plurality of line patterns, each line pattern being associated with an ink ejecting nozzle and varying in one-dimension;
computer program code means for imaging said printed test chart to generate an imaged test chart, each line pattern in the imaged test chart being distinguishable from adjacent line patterns;
computer program code means for analyzing said imaged test chart to determine if each of said line patterns exists at an expected location in said printed test chart; and
computer program code means for, if at least one line pattern does not exist at an expected location, determining the ink ejecting nozzle corresponding to said line pattern is not functioning.
